(19) United States
(12) Patent Application Publication
(10) Pub. No.: US 2026/0328040 A1
(43) Pub. Date: Oct. 22, 2026

(54) GUIDE RAIL FOR POWER SWING DOOR DRIVE UNIT

(71) Applicant: STRATTEC POWER ACCESS LLC, Auburn Hills, MI (US)

(72) Inventors: Gregory V. Sproule, Linden, MI (US); Kimpon Ngem, Grant Township, MI (US)

(21) Appl. No.: 19/648,425

(22) Filed: Apr. 15, 2026

Related U.S. Application Data
(60) Provisional application No. 63/792,574, filed on Apr. 22, 2025.

(51) Int. Cl. E05F 15/622

(52) U.S. Cl. CPC E05F 15/622; E05Y 2201/10; E05Y 2201/70; E05Y 2201/702; E05Y 2900/531

(57) ABSTRACT

A drive unit for a power swing door on a vehicle includes a housing, an actuator, and a linkage coupled to the actuator and moveable relative to the housing between a first, retracted position and a second, extended position. The drive unit further includes a carrier coupled to the linkage, and a guide rail positioned in the housing. The carrier slides along the guide rail.

### CROSS-REFERENCE TO RELATED APPLICATIONS

This application claims priority to U.S. Provisional Application No. 63/792,574, filed Apr. 22, 2025, the entire contents of which are incorporated herein by reference.

### FIELD

This disclosure relates generally to doors on vehicles, including power swing doors on motor vehicles.

### SUMMARY

In one aspect, the disclosure provides a drive unit for a power swing door on a vehicle. The drive unit includes a housing, an actuator, and a linkage coupled to the actuator and moveable relative to the housing between a first, retracted position and a second, extended position. The drive unit further includes a carrier coupled to the linkage, and a guide rail positioned in the housing. The carrier slides along the guide rail.

Other aspects of the disclosure will become apparent by consideration of the detailed description and accompanying drawings.

### BRIEF DESCRIPTION OF THE DRAWINGS

FIG. 1 is a schematic view of a vehicle having a power swing door and a drive unit according to one example.

FIG. 2 is a side view of the drive unit of FIG. 1, illustrating a linkage in a retracted position.

FIG. 3 is a side view of the drive unit of FIG. 1, illustrating the linkage in an extended position.

FIG. 4 is a top view of the drive unit of FIG. 1, illustrating the linkage in the extended position.

FIG. 5 is a cross-sectional view of the drive unit of FIG. 1, illustrating internal components of the drive unit.

FIG. 6 is a perspective view of a guide rail of the drive unit of FIG. 1.

FIG. 7 is a perspective view of the linkage and a carrier of the drive unit of FIG. 1.

FIG. 8 is an exploded, perspective view of a leadscrew, a leadscrew nut, and the carrier of the drive unit of FIG. 1.

FIGS. 9 and 10 are perspective views of an end cap of the drive unit of FIG. 1.

FIG. 11 is a cross-sectional view of the drive unit of FIG. 1, taken along lines 11-11 in FIG. 5.

FIG. 12 is a cross-sectional view of the drive unit of FIG. 1, taken along lines 12-12 in FIG. 5.

### DETAILED DESCRIPTION

Before any examples of the present disclosure are explained in detail, it is to be understood that the disclosure is not limited in its application to the details of construction and the arrangement of components set forth in the following description or illustrated in the following drawings. The disclosure is capable of other examples and of being practiced or of being carried out in various ways.

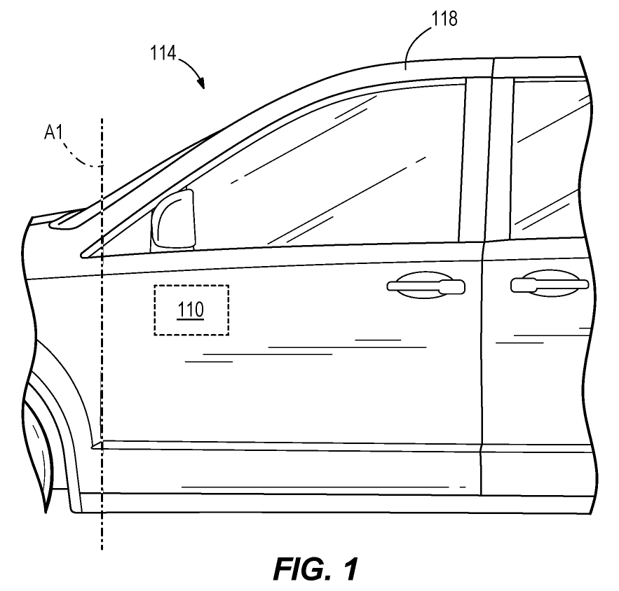

FIGS. 1-12 illustrate a drive unit 110 for use on a motor vehicle. The drive unit 110 may be used, for example, for powering a swing door on a motor vehicle, or for any other moving (e.g., pivoting) component on a motor vehicle or other structure. The drive unit 110 may include, for example, one or more motors, gears, clutches, sensors, couplers, tracks, carriers, and/or linkages to power the movement of the power swing door.

With reference to FIG. 1, in the illustrated example the drive unit 110 forms part of an overall motor vehicle 114, and is coupled to a power swing door 118 (e.g., a driver side door, a passenger side door, or other power swing door) of the motor vehicle 114. The power swing door 118 pivots about a pivot axis A1 (e.g., a vertical hinge axis), and the drive unit 110 is used to drive a pivoting motion of the power swing door 118 about the axis A1. The drive unit 110 may be located, for example, in what is commonly referred to as a check-link area of the motor vehicle 114, wherein the check-link is replaced with the drive unit 110. In other examples, the drive unit 110 may be located elsewhere on or within the motor vehicle 114.

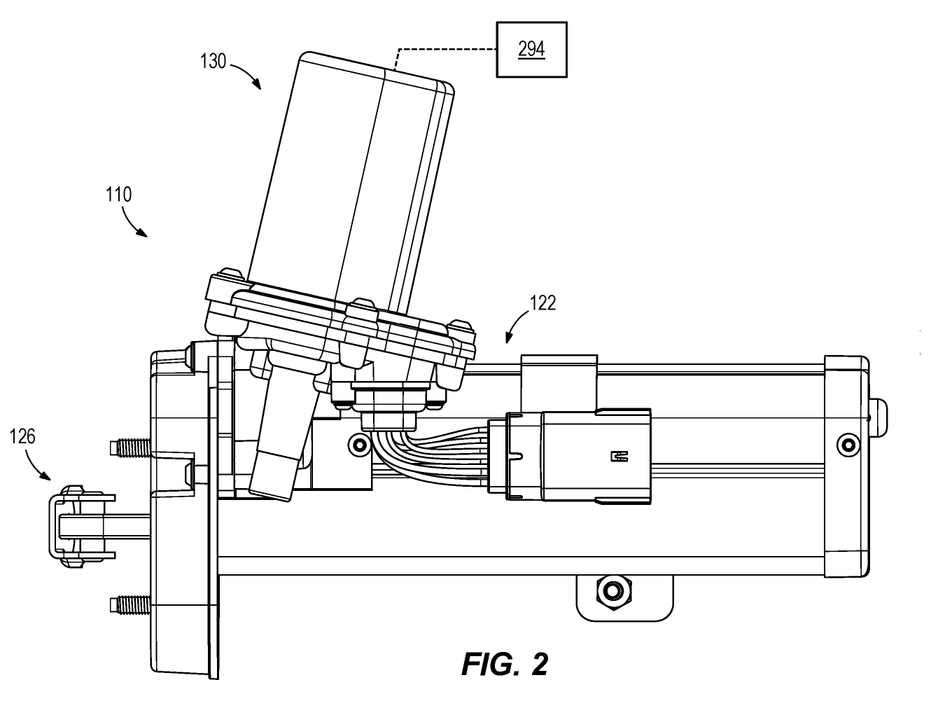

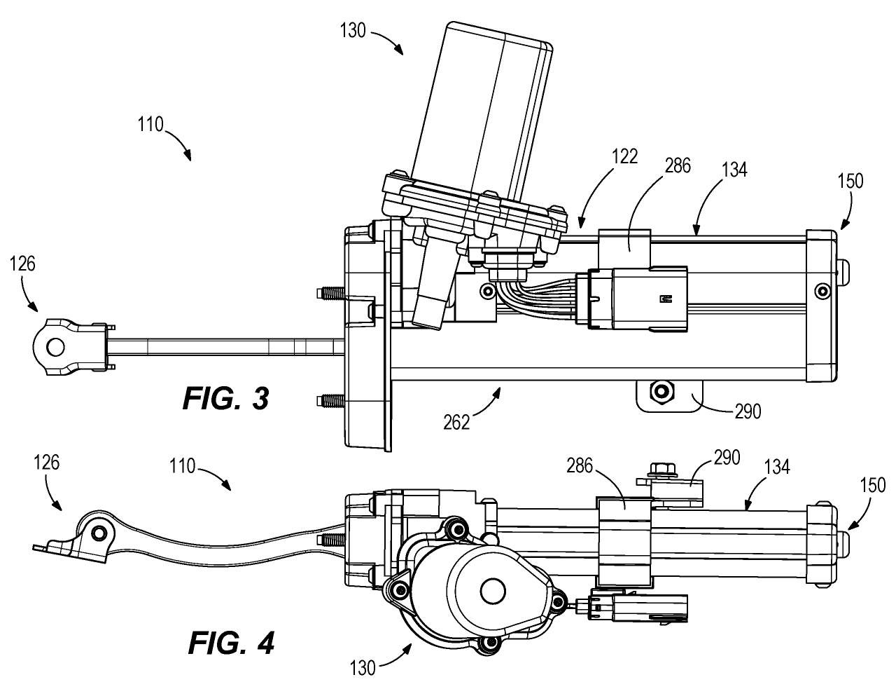

With reference to FIGS. 2-5, the drive unit 110 includes a housing 122 and a linkage 126 coupled to the housing 122. The linkage 126 is movable relative to the housing 122 for example between a first, retracted position (FIG. 2) and a second, extended position (FIGS. 3 and 4). In the first, retracted position the power swing door 118 may be in a closed position, and in the second, extended position the power swing door 118 may be in an open position. In other examples, various other positions and/or orientations of the linkage 126 may be used to move the power swing door 118 between different positions (e.g., an open position, a closed position, a partially-open position, etc.). Additionally, in other examples, the linkage 126 may have other shapes and/or sizes than that illustrated, and/or may include a combination of different multiple linkage elements that are linked together.

With continued reference to FIGS. 2-5, the drive unit 110 additionally includes an actuator 130 that drives movement of the linkage 126 relative to the housing 122 (e.g., between the closed position and the open position). In the illustrated example, the actuator 130 is coupled to a top of the housing 122, although in other examples the actuator 130 may be coupled to any other location of the housing 122, or may otherwise be located in a position other than that illustrated. The actuator 130 may include any type of actuator (e.g., an electric motor, a pneumatic actuator, a hydraulic actuator, etc.), and may include various components such as gear assemblies, clutches, etc. In the illustrated example, the actuator 130 is an electric motor.

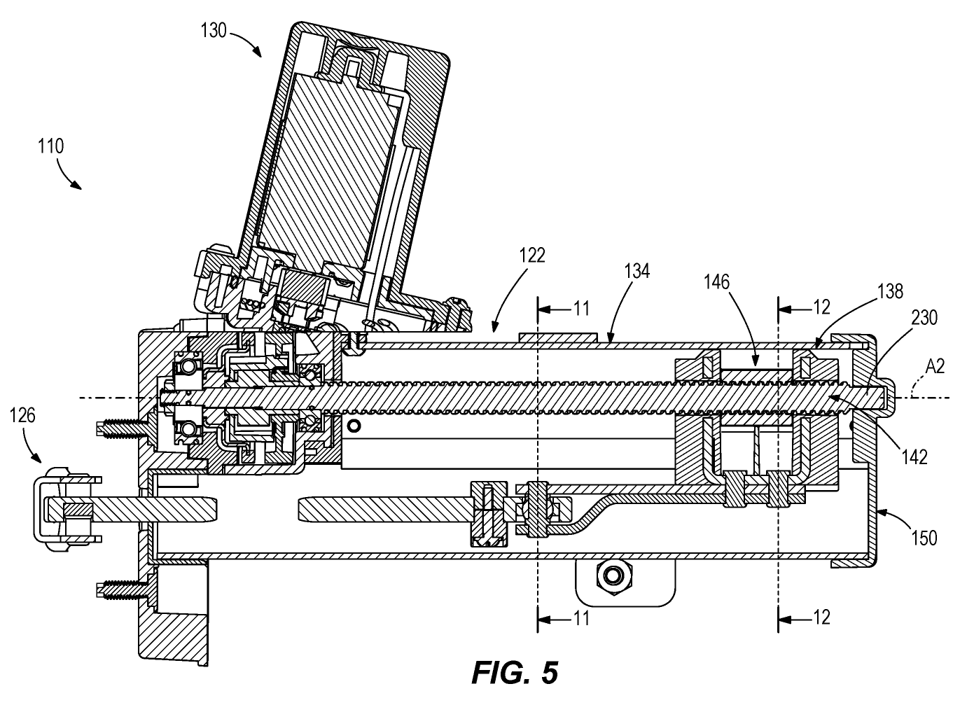

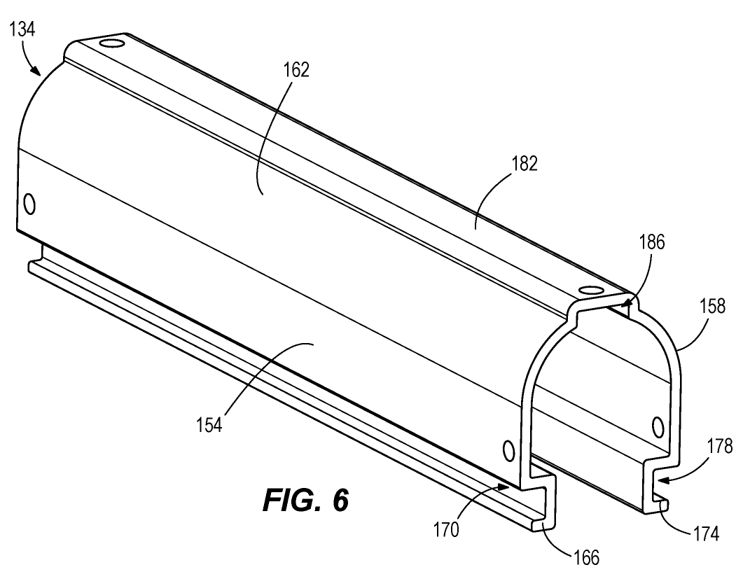

With reference to FIG. 5, in the illustrated example the drive unit 110 includes a guide rail 134, a carrier 138 that is coupled to the linkage 126 and is positioned to at least partially slide along (e.g., within) the guide rail 134 (or other rail or guide structure), a leadscrew 142 that extends along an axis A2 into the carrier 138 and is rotationally driven about the axis A2 by the actuator 130, a leadscrew nut 146 coupled to leadscrew 142 and the carrier 138, and an end cap 150 that is coupled to the housing 122. Other examples may include other numbers and arrangements of components.

With reference to FIG. 6, in the illustrated example the guide rail 134 forms an upper portion of the housing 122, and has generally a C-shape or U-shape configuration and/or cross-section (e.g., as viewed along the axis A2). Other examples may include other shapes and sizes than that illustrated. Additionally, while the illustrated guide rail 134 forms an upper region of the housing 122, in other examples the drive unit 110 may include a separate upper housing, and the guide rail 134 may be located within the separate upper housing (e.g., under the separate upper housing).

With continued reference to FIG. 6, in the illustrated example the guide rail 134 includes a first leg 154, a second, opposite leg 158, and an upper connecting region 162 that arches over from a top of the first leg 154 to a top of the second leg 158. In some examples, the first leg 154 extends parallel to the second leg 158. Other examples of the guide rail 134 include other numbers of legs, connecting regions, or other structures.

With continued reference to FIG. 6, the guide rail 134 may define at least one guide rail keyed feature. In the illustrated example, the guide rail 134 includes a first guide rail keyed feature in the form of an inwardly extending protrusion 166 along the first leg 154 (e.g., at or near a lower end of the first leg 154). As seen in FIG. 6, the inwardly extending protrusion 166 has a rectangular configuration and/or cross-section, and defines a first, exterior guide rail channel 170 along an exterior of the first leg 154.

The guide rail 134 further includes a second guide rail keyed feature in the form of an inwardly extending protrusion 174 along the second leg 158 (e.g., at or near a lower end of the second leg 158). As seen in FIG. 6, the inwardly extending protrusion 174 has a rectangular configuration and/or cross-section, and defines a second, exterior guide rail channel 178 along an exterior of the second leg 158.

The guide rail 134 further includes a third guide rail keyed feature in the form of an outwardly extending protrusion 182 along the connecting region 162. As seen in FIG. 6, the outwardly extending protrusion 182 has a rectangular configuration and/or cross-section, and defines a third, interior guide rail channel 186 along an interior of the connecting region 162.

Other examples of the guide rail 134 may include various other numbers and/or arrangements of guide rail keyed features, including for example inwardly extending or outwardly extending protrusions of various shapes and/or sizes (including shapes and sizes other than that illustrated) defining one or more guide rail channels. In other examples, the guide rail 134 does not include any guide rail keyed features.

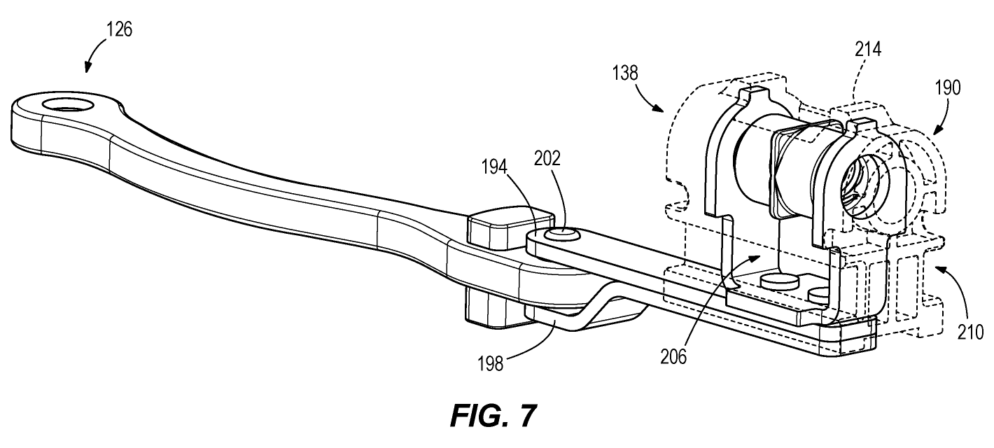

With reference to FIG. 7, in the illustrated example the carrier 138 includes a carrier main body 190 (shown partially with dashed line), a first lower bracket 194 coupled (e.g., fixed with a fastener or fasteners) to the carrier main body 190 (e.g., along a bottom of the carrier main body 190), and a second lower bracket 198 coupled (e.g., fixed with a fastener or fasteners) to the first lower bracket 194 (e.g., along a bottom of the first lower bracket 194). Other examples may include other numbers or arrangements of lower brackets or other structures that couple the carrier main body 190 to the linkage 126. In some examples, the carrier main body 190 is coupled directly to the linkage 126.

As illustrated in FIG. 7, in some examples the carrier 138 is coupled (e.g., pivotally coupled) to the linkage 126 via an interface member 202 (e.g., a pivot pin) that extends through the first lower bracket 194 and the second lower bracket 198 at an axial distance away from the carrier main body 190. Other examples of the carrier 138 may include various other numbers and/or arrangements of housings, brackets, or other components, and/or other types of connections to the linkage 126.

With continued reference to FIG. 7, in the illustrated example the carrier 138 defines at least one carrier keyed feature configured to engage at least one of the guide rail keyed features as described above to rotationally lock the carrier 138 to the guide rail 134 and guide the carrier 138 along the axis A1. In the illustrated example, the carrier 138 includes a first carrier keyed feature in the form of a first carrier channel 206 along an exterior of the carrier main body 190 that is sized and shaped to receive the inwardly extending protrusion 166 (FIG. 6) of the first leg 154 of the guide rail 134.

The carrier 138 further includes a second carrier keyed feature in the form of a second carrier channel 210 along an exterior of the carrier main body 190 that is sized and shaped to receive the inwardly extending protrusion 174 (FIG. 6) of the second leg 158 of the guide rail 134. The first carrier channel 206 is located opposite the second carrier channel 210 along the carrier main body 190.

The carrier 138 further includes a third carrier keyed feature in the form of an outwardly extending protrusion(s) 214 along a top of the carrier main body 190 that is sized and shaped to extend into the third, interior guide rail channel 186 (FIG. 6) of the guide rail 134. Other examples of the carrier 138 may include various other numbers and/or arrangements of keyed features, including for example inwardly extending or outwardly extending channels and/or protrusions of various shapes and/or sizes (including shapes and sizes other than that illustrated).

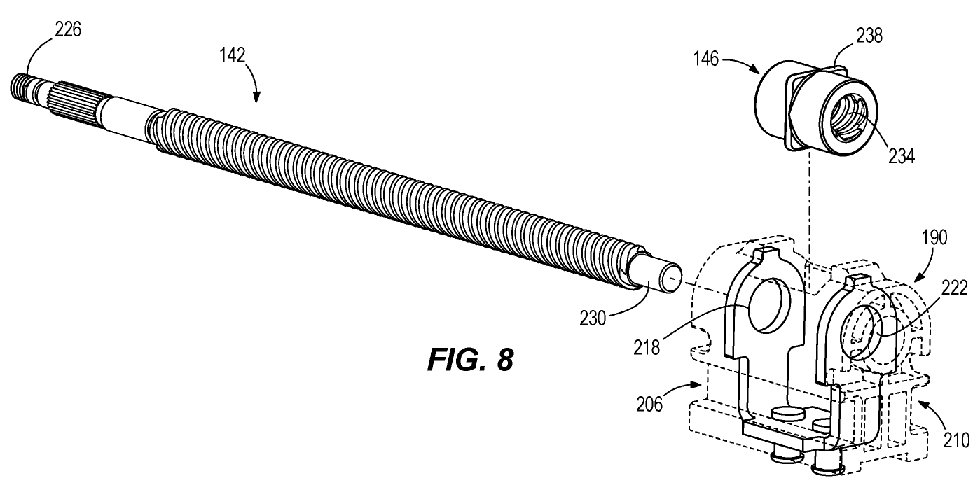

With reference to FIG. 8, in the illustrated example the carrier main body 190 includes a first carrier main body aperture 218 at a first end of the carrier main body 190, and a second carrier main body aperture 222 at a second, opposite end of the carrier main body 190. The second carrier main body aperture 222 is spaced from the first carrier main body aperture 218 along the axis A2. As illustrated in FIG. 8, the leadscrew 142, which extends along the axis A2, includes a first leadscrew end 226 and a second, opposite leadscrew end 230 spaced from the first leadscrew end 226 along the axis A2. The first leadscrew end 226 is coupled (e.g., directly) to the actuator 130, and the second leadscrew end 230 is sized and shaped to extend through the first carrier main body aperture 218 and the second carrier main body aperture 222 along the axis A2.

With continued reference to FIG. 8, in some examples the leadscrew nut 146 is sized and shaped to sit within the carrier main body 190 (e.g., be entirely enclosed within the carrier main body 190 or at least nestled partially within a portion of the carrier main body 190). The leadscrew nut 146 includes a threaded leadscrew nut aperture 234 that extends along the axis A2. The threaded leadscrew nut aperture 234 is sized and shaped to receive and engage at least a portion of the leadscrew 142 (e.g., a threaded portion between the first leadscrew end 226 and the second leadscrew end 230), such that external threads on the leadscrew 142 engage with internal threads in the threaded leadscrew nut aperture 234.

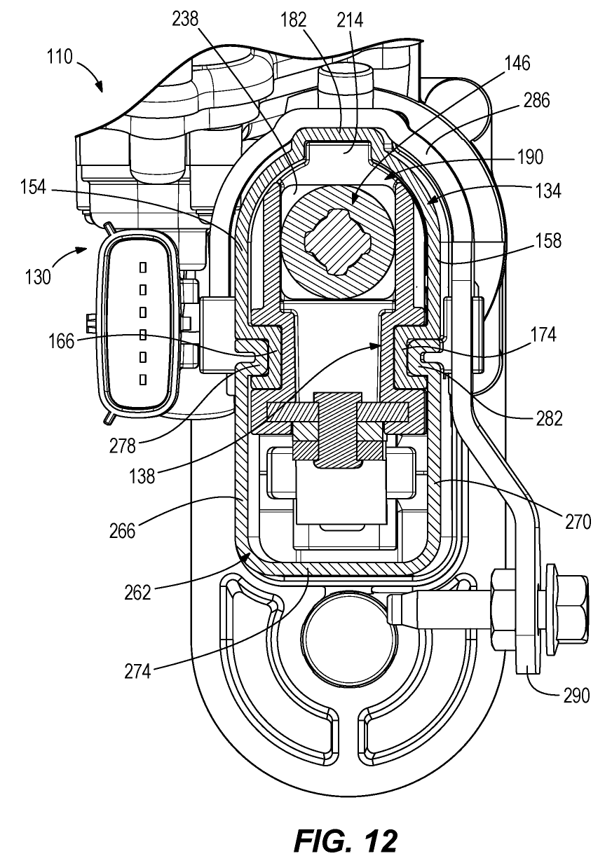

With continued reference to FIG. 8, in some examples the leadscrew nut 146 further includes an anti-rotation feature that inhibits or prevents rotation of the leadscrew nut 146. In the illustrated example, the anti-rotation feature is in the form of a generally rectangular flange(s) 238. As illustrated in FIG. 12, the flange 238 is sized and shaped to sit within the carrier main body 190 and engage an interior wall or walls of the carrier main body 190 to inhibit or prevent rotation of the leadscrew nut 146 relative to the carrier main body 190 and the carrier 138 overall when the leadscrew 142 is driven to rotate about the axis A2. In some examples, the leadscrew nut 146 is a free-floating component, generally floats relative to the carrier 138. Other examples of the leadscrew nut 146 may include various other shapes and sizes than that illustrated, as well as various other numbers, arrangements, shapes, and/or sizes of anti-rotation features (e.g., rectangular flanges or other protrusions or surfaces).

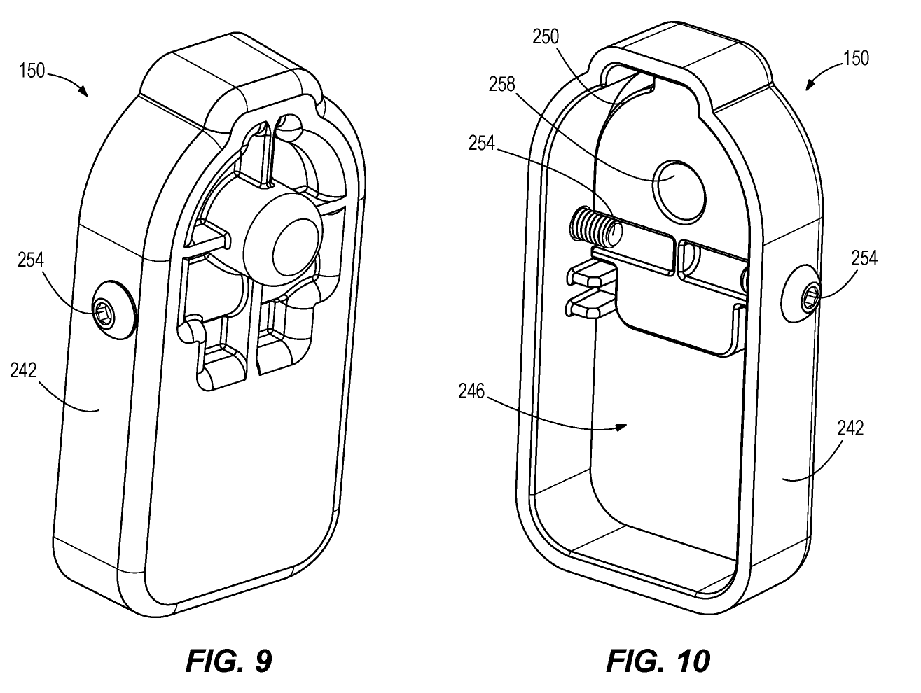

With reference to FIGS. 9 and 10, the end cap 150 includes an end cap main body 242 that defines an interior space 246. The interior space 246 is open to the interior of the housing 122. The end cap 150 further includes at least one alignment feature that facilitates positioning (including for example alignment) of the guide rail 134 and/or inhibits or prevents the guide rail 134 from flexing or deforming. In the illustrated example, the alignment feature is in the form of a guide slot 250. The guide slot 250 is curved to generally match the curvature of the arched upper connecting region 162 of the guide rail 134. The guide slot 250 is sized and shaped to position the guide rail 134. For example, the arched upper connecting region 162 of the guide rail 134 may slide into the guide slot 250. The guide slot 250 is also sized and shaped to inhibit the guide rail 134 from expanding or contracting along a direction that is perpendicular to the axis A2. For example, the material defining the curved guide slot 250 may inhibit or prevent the arched upper connecting region 162 from flexing inwardly. In some examples, and as seen in FIGS. 9 and 10, fasteners 254 also extend through the end cap main body 242, and through the guide rail 134 (not shown), to further lock and secure the guide rail 134 in place, and secure the end cap 150 to the guide rail 134. Other examples may include other numbers and arrangements of fasteners 254 and/or guide slots 250, or may not include fasteners 254 or guide slots 250.

With continued reference to FIGS. 9 and 10, in some examples the end cap 150 additionally or alternatively includes an alignment feature that facilitates positioning (including for example alignment) of the leadscrew 142. In the illustrated example this alignment feature is in the form of an end cap recess 258 within the end cap main body 190. The end cap recess 258 is sized and shaped to receive the second leadscrew end 230 of the leadscrew 142, and to support the leadscrew 142 within the overall housing 122. As illustrated in FIG. 8, the second leadscrew end 230 is unthreaded. This unthreaded region of the leadscrew 142 sits at least partially within the end cap recess 258, and rotates freely within the end cap recess 258 (along with the rest of the leadscrew 142).

Other examples of the end cap 150 may have various other shapes and sizes, and also other types, shapes, and sizes of alignment features (e.g., ribs or other protrusions, recesses, etc.) for aligning the guide rail 134 and/or the leadscrew 142. In some examples, the end cap 150 does not include any alignment features. Additionally, in some examples, the end cap 150 is not included at all.

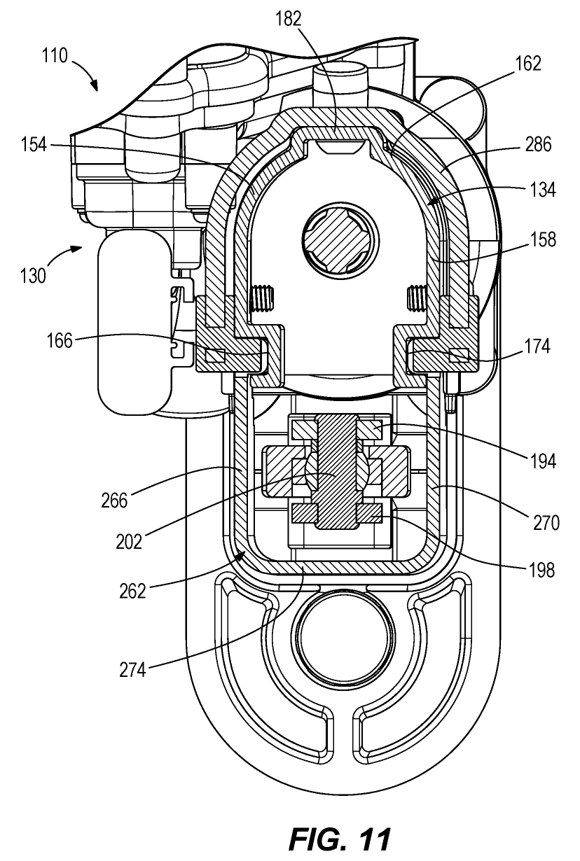

With reference to FIGS. 3, 11, and 12, the housing 122 overall may additionally include a lower housing element 262 that is coupled to the guide rail 134. In the illustrated example, and as seen in FIGS. 11 and 12, the lower housing element 262 is generally C-shaped or U-shaped, and includes a first lower housing element arm 266, a second (e.g., opposite) lower housing element arm 270, and a connecting region 274 that connects the first lower housing element arm 266 to the second lower housing element arm 270. As seen in FIG. 12, the first lower housing element arm 266 defines a first lower housing element protrusion 278 that is sized and shaped to fit into (e.g., snap into) the first exterior guide rail channel 170 of the guide rail 134 (FIG. 6). Similarly, the second lower housing element arm 270 defines a second lower housing element protrusion 282 that is sized and shaped to fit into (e.g., snap into) the second exterior guide rail channel 178 of the guide rail 134. In the illustrated example, the lower housing element 262 is removably coupled to the guide rail 134, and for example may be snapped onto the guide rail 134. In other examples, the lower housing element 262 is fixed (e.g., with one or more fasteners) to the guide rail 134. Other examples may include other manners by which to couple (e.g., releasably couple or fix) the lower housing element 262 to the guide rail 134.

Other examples may include other numbers and/or shapes and sizes of components for the lower housing element 262. In some examples, the housing 122 does not include the lower housing element 262. For example, the lower housing element 262 may be omitted, and the housing 122 may be formed entirely of the guide rail 134 itself. In yet other examples, the housing 122 includes more than one lower housing element 262.

With reference to FIGS. 3, 4, 11, and 12, in some examples the drive unit 110 additionally includes a fastening bracket 286 that facilitates attachment of the drive unit 110 to the motor vehicle 114. In the illustrated example, the fastening bracket 286 is curved, and extends over a top of the guide rail 134. The fastening bracket 286 may be fixed for example to the guide rail 134 (e.g., with one or more fasteners), or otherwise secured to the guide rail 134 (e.g., via a snap fit arrangement and/or frictional fit). In the illustrated example, the fastening bracket 286 includes a distal fastening region 290 (e.g., arm) that extends away from the guide rail 134, and may be used for example to fix the overall dive unit 110 to the motor vehicle 114. Other examples may include other types or numbers of fastening brackets 286, or may use other structures (e.g., including fasteners) to secure the drive unit 110 to the motor vehicle 114 (or other structure).

With reference overall to FIGS. 2-12, during operation of the drive unit 110, the actuator 130 may first be activated. For example, as seen in FIG. 2, the motor vehicle 114 may include a controller 294 coupled to the actuator 130. The controller 294 provides a signal to the actuator 130 (e.g., based on user input or other input from the motor vehicle 114), and the actuator 130 generates rotation of the leadscrew 142. As described above, the actuator 130 may include a motor (e.g., electric motor) and/or one or more drive or gears or other structures that may facilitate eventual rotation of the leadscrew 142.

As illustrated in FIG. 5, once the actuator 130 is activated, the leadscrew 142 will rotate about the axis A1, and the threaded leadscrew 142 will engage the threaded leadscrew nut aperture 234 (FIG. 8) of the leadscrew nut 146. The leadscrew nut 146 freely floats within the carrier 138, and is prevented from rotating via the flange 238 (FIG. 8). Accordingly, rotation of the leadscrew 142 about the axis A1 forces a linear movement of the carrier 138 along the guide rail 134.

As described above, and as seen in FIG. 12, the carrier 138 may be sized and shaped to correspond to the size and shape of the guide rail 134, such that the carrier 138 slides within the guide rail 134 along the axis A1 during this linear movement. The inwardly extending protrusion 166 along the first leg 154 of the guide rail 134 fits into the first carrier channel 206 (FIG. 7) of the carrier main body 190, the inwardly extending protrusion 174 of the second leg 158 of the guide rail 134 fits into the second carrier channel 210 (FIG. 7) of the carrier main body 190, and the outwardly extending protrusion 214 of the carrier main body 190 fits into the third guide rail channel 186 of the guide rail 134, to thereby further secure carrier 138 and inhibit tilting and/or rotation of the carrier 138 about the axis A1 as the carrier slides linearly along the axis A1.

With continued reference to FIGS. 2-12, the linear movement of the carrier 138 along the axis A1 forces movement of the linkage 126 from the first, retracted position (FIG. 2) to the second, extended position (FIG. 3), or vice versa. Once a desired position of the linkage 126 and/or the vehicle’s power swing door 118 is obtained, the actuator 130 is then turned off, or paused, until the controller 294 is eventually used again to activate the actuator 130 and move the linkage 126.

Some of the examples may be further described by reference to the following numbered clauses:

1. A drive unit for a power swing door on a vehicle, the drive unit comprising:
a housing;
an actuator;
a linkage coupled to the actuator and configured to be moved relative to the housing between a first, retracted position and a second, extended position;
a carrier coupled to the linkage; and
a guide rail positioned in the housing, wherein at least a portion of the carrier is configured to slide along the guide rail.

2. The drive unit of clause 1, further comprising a leadscrew nut coupled to the carrier, and a leadscrew coupled to both the leadscrew nut and to the actuator.

3. The drive unit of clause 2, wherein the leadscrew nut is rotationally fixed to the carrier, wherein the actuator is configured to generate rotation of the leadscrew nut about an axis, forcing a linear movement of the carrier along the guide rail and the axis.

4. The drive unit of clause 3, wherein the leadscrew nut is positioned entirely within the carrier, and is a free-floating leadscrew nut.

5. The drive unit of clause 4, wherein the guide rail defines a first keyed feature, and wherein the carrier defines a second keyed feature configured to engage the first keyed feature to rotationally lock the carrier to the guide rail and guide the carrier along the axis.

6. The drive unit of clause 5, wherein the first keyed feature is an inwardly extending protrusion of the guide rail, and wherein the second keyed feature is a channel along an exterior of the carrier that is sized and shaped to receive the inwardly extending protrusion.

7. The drive unit of clause 6, wherein the channel is a first channel, wherein the inwardly extending protrusion of the guide rail defines a second channel along an exterior of the guide rail.

8. The drive unit of clause 7, wherein the guide rail defines an upper portion of the housing, wherein the housing includes a separate, lower housing element having a region that is positioned at least partially within the second channel.

9. The drive unit of clause 8, further comprising an end cap coupled to the housing, wherein the end cap includes a guide rib sized and shaped to position the guide rail and inhibit the guide rail from expanding or contracting along a direction that is perpendicular to the axis.

10. The drive unit of any of the preceding clauses, wherein the guide rail defines a first keyed feature, and wherein the carrier defines a second keyed feature configured to engage the first keyed feature to rotationally lock the carrier to the guide rail and guide the carrier along an axis.

11. The drive unit of clause 10, wherein the first keyed feature is an inwardly extending protrusion of the guide rail, and wherein the second keyed feature is a channel along an exterior of the carrier that is sized and shaped to receive the inwardly extending protrusion.

12. The drive unit of clause 11, wherein the channel is a first channel, wherein the inwardly extending protrusion of the guide rail defines a second channel along an exterior of the guide rail.

13. The drive unit of clause 12, wherein the guide rail defines an upper portion of the housing, wherein the housing includes a separate, lower housing element having a region that is positioned at least partially within the second channel.

14. The drive unit of clause 13, further comprising an end cap coupled to the housing, wherein the end cap includes a guide rib sized and shaped to position the guide rail and inhibit the guide rail from expanding or contracting along at least one direction.

15. The drive unit of any of the preceding clauses, wherein the guide rail defines an upper portion of the housing, wherein the housing includes a separate, lower housing element engaged with the guide rail.

16. The drive unit of any of the preceding clauses, wherein the guide rail defines at least one channel.

17. The drive unit of clause 16, wherein the guide rail defines a first, exterior channel along a first side of the guide rail, a second, exterior channel along a second, opposite side of the guide rail, and a third, interior channel along a top of the guide rail.

18. The drive unit of any of the preceding clauses, wherein the carrier is pivotally coupled to the linkage via a pivot pin.

19. The drive unit of any of the preceding clauses, further comprising an end cap coupled to the housing.

20. The drive unit of clause 19, wherein the end cap includes a guide rib sized and shaped to position the guide rail and inhibit the guide rail from expanding or contracting along at least one direction.

Although the disclosure has been described in detail referring to certain preferred embodiments, variations and modifications exist within the scope and spirit of one or more independent aspects of the disclosure as described.

What is claimed is:

1. A drive unit for a power swing door on a vehicle, the drive unit comprising:
a housing;
an actuator;
a linkage coupled to the actuator and configured to be moved relative to the housing between a first, retracted position and a second, extended position;
a carrier coupled to the linkage; and
a guide rail positioned in the housing, wherein at least a portion of the carrier is configured to slide along the guide rail.

2. The drive unit of claim 1, further comprising a leadscrew nut coupled to the carrier, and a leadscrew coupled to both the leadscrew nut and to the actuator.

3. The drive unit of claim 2, wherein the leadscrew nut is rotationally fixed to the carrier, wherein the actuator is configured to generate rotation of the leadscrew nut about an axis, forcing a linear movement of the carrier along the guide rail and the axis.

4. The drive unit of claim 3, wherein the leadscrew nut is positioned entirely within the carrier, and is a free-floating leadscrew nut.

5. The drive unit of claim 4, wherein the guide rail defines a first keyed feature, and wherein the carrier defines a second keyed feature configured to engage the first keyed feature to rotationally lock the carrier to the guide rail and guide the carrier along the axis.

6. The drive unit of claim 5, wherein the first keyed feature is an inwardly extending protrusion of the guide rail, and wherein the second keyed feature is a channel along an exterior of the carrier that is sized and shaped to receive the inwardly extending protrusion.

7. The drive unit of claim 6, wherein the channel is a first channel, wherein the inwardly extending protrusion of the guide rail defines a second channel along an exterior of the guide rail.

8. The drive unit of claim 7, wherein the guide rail defines an upper portion of the housing, wherein the housing includes a separate, lower housing element having a region that is positioned at least partially within the second channel.

9. The drive unit of claim 8, further comprising an end cap coupled to the housing, wherein the end cap includes a guide rib sized and shaped to position the guide rail and inhibit the guide rail from expanding or contracting along a direction that is perpendicular to the axis.

10. The drive unit of claim 1, wherein the guide rail defines a first keyed feature, and wherein the carrier defines a second keyed feature configured to engage the first keyed feature to rotationally lock the carrier to the guide rail and guide the carrier along an axis.

11. The drive unit of claim 10, wherein the first keyed feature is an inwardly extending protrusion of the guide rail, and wherein the second keyed feature is a channel along an exterior of the carrier that is sized and shaped to receive the inwardly extending protrusion.

12. The drive unit of claim 11, wherein the channel is a first channel, wherein the inwardly extending protrusion of the guide rail defines a second channel along an exterior of the guide rail.

13. The drive unit of claim 12, wherein the guide rail defines an upper portion of the housing, wherein the housing includes a separate, lower housing element having a region that is positioned at least partially within the second channel.

14. The drive unit of claim 13, further comprising an end cap coupled to the housing, wherein the end cap includes a guide rib sized and shaped to position the guide rail and inhibit the guide rail from expanding or contracting along at least one direction.

15. The drive unit of claim 1, wherein the guide rail defines an upper portion of the housing, wherein the housing includes a separate, lower housing element engaged with the guide rail.

16. The drive unit of claim 1, wherein the guide rail defines at least one channel.

17. The drive unit of claim 16, wherein the guide rail defines a first, exterior channel along a first side of the guide rail, a second, exterior channel along a second, opposite side of the guide rail, and a third, interior channel along a top of the guide rail.

18. The drive unit of claim 1, wherein the carrier is pivotally coupled to the linkage via a pivot pin.

19. The drive unit of claim 1, further comprising an end cap coupled to the housing.

20. The drive unit of claim 19, wherein the end cap includes a guide rib sized and shaped to position the guide rail and inhibit the guide rail from expanding or contracting along at least one direction.
